(19) United States
(12) Patent Application Publication
(10) Pub. No.: US 2023/0380939 A1
(43) Pub. Date: Nov. 30, 2023

(54) PRESCRIPTION ATTACHMENTS FOR USE IN EACH PHASE OF COMBINATION ORTHODONTIC TREATMENT

(71) Applicant: 3M INNOVATIVE PROPERTIES COMPANY, St. Paul, MN (US)

(72) Inventors: Ming-Lai Lai, Afton, MN (US); Ralf M. Paehl, Melle (DE); Joseph R. Dufour, Cottage Grove, MN (US)

(21) Appl. No.: 18/266,468

(22) PCT Filed: Jan. 6, 2022
(86) PCT No.: PCT/IB2022/050086

§ 371 Date: Jun. 9, 2023

Related U.S. Application Data
(60) Provisional application No. 63/135,153, filed on Jan. 8, 2021.

(51) Int. Cl. A61C 7/14; A61C 7/08; A61C 7/28; A61C 7/30

(52) U.S. Cl. CPC A61C 7/146; A61C 7/08; A61C 7/282; A61C 7/30

(57) ABSTRACT

Attachments of the present disclosure combines the optimal practices of the traditional bracket-wire system and more recent resilient appliance (e.g., CTAs and polymeric bands) systems. The attachments include prescribed in/outs, torques and angulations designed utilizing the straight wire methodology for determining the bonding location on a particular tooth of the dental arch. A marriage of bracket prescription with attachment placement can help the treating professional to better visualize the treatment outcome with the tray or band on the patient.

### TECHNICAL FIELD

The present disclosure generally to orthodontic appliances, their preparation, and use.

### BACKGROUND

The field of orthodontics relates to repositioning a patient's teeth for improved function and aesthetic appearance. Orthodontic devices and treatment methods generally involve the application of forces to move teeth into a proper bite configuration, or occlusion. As one example, orthodontic treatment may involve the use of slotted appliances, known as brackets, which are fixed to the patient's anterior, cuspid, and bicuspid teeth. An archwire is typically placed in the slot of each bracket and serves as a track to guide movement of the teeth to desired orientations. The ends of the archwire are usually received in appliances known as buccal tubes that are secured to the patient's molar teeth. Such dental appliances remain in the mouth of the patient and are periodically adjusted by an orthodontist to check the process and maintain the proper force on the teeth until proper alignment is achieved.

There are numerous methods for selecting orthodontic appliances and archwires. Particular selection methods used by a practitioner are generally related to the type of orthodontic techniques that are expected to be employed during the course of orthodontic therapy. For example, one exemplary technique is known as the “straight wire” technique. This technique involves the use of brackets having slots that are designed to be in a common plane once the teeth have moved to desired, final positions. Although the slots of the brackets are not aligned at the beginning of treatment due to the various malpositions of the teeth, the inherent resilience of the archwire provides a restoring force that tends to move the archwire and hence the slots of the associated brackets into alignment in a common plane.

In the straight wire technique described above, each of the selected brackets has a certain “prescription” that represents particular characteristics of the bracket. The prescription can include numerous different aspects or features of the bracket, such as the size of the archwire slot, as well as orientation of a slot relative to a base of the bracket that is intended to be mounted on a surface of the tooth. The prescription describes the orientation of the archwire slot relative to the base of the bracket and may include values for torque, angulation, and rotation. In terms of tooth movement, “torque” is often defined as tipping movement of the long axis of the tooth in a buccolabial-lingual direction (i.e., in directions toward and away from the patient's lips or cheeks and the patient's tongue), “angulation” is defined as tipping movement of the long axis of the tooth in mesial and distal directions (i.e., in directions toward and away from the center of the patient's dental arch), and “rotation” is defined as rotational movement of the tooth about its long axis.

Orthodontic treatment may also involve the use of alignment trays, such as clear or transparent, polymer-based tooth positioning trays, often referred to as clear tray aligners (CTAs). For example, orthodontic treatment with CTAs may include forming a tray having shells that engage one or more teeth. Each shell may be deformed from an initial position of a tooth, e.g., a malocclusion position. The deformed position of a respective shell of the CTA may apply a force to a respective tooth toward a desired position of the tooth that is an intermediate position between the initial position and a final position resulting from the orthodontic treatment. In some examples, small attachments may be bonded to the teeth to improve force application or achieve desired tooth movements. Proper placement of attachments may ensure proper engagement and interaction of the attachment with a designed feature on the CTAs. The designed feature may provide a desired physical leverage which creates a desired force on a tooth to produce a specific movement of the tooth during treatment. Attachments are typically constructed of varying materials, shapes and sizes, and can be bonded to the labial or lingual surfaces of teeth in order to interact with CTAs and removable appliances in a variety of different ways. Attachments can be applied to a patient's teeth prior to treatment with aligners. Attachments may also be fabricated prior to tooth attachment. Attachments may also be substantially assembled at the orthodontic practitioner's office prior to, or in conjunction with, positioning on the patient's tooth (e.g., molded composites, etc.).

CTAs may be used in cooperation with braces as appropriate to effect full treatment of the teeth when in more severe occlusion, a practice commonly referred to as a “combination treatment”. The CTAs may be used either before or after the wire and bracket appliance(s). Generally, less severe malocclusions are those in which it is expected that the patient may be treated only with CTAs and attachments in order to achieve a desired treatment outcome. In contrast, patients who have a more severe malocclusion, will usually require a combination treatment. The particular order and/or repetition of appliances may be selected depending on the particular patient requirements. Combination treatments are explored in further detail in U.S. Pat. No. 9,333,052 (Miller) and US Patent Publication No. 20150132707 (Huang et al.).

Similar treatments may be effectuated with a resilient polymeric arch member dimensioned to extend over either the labial or lingual surfaces of the teeth of the arch but lacking a tray structure (see e.g., US Patent Publication No. 2005/0277084).

### SUMMARY

The present disclosure provides attachments that are uniquely suitable for use as both orthodontic brackets and CTA or band attachments in a combination treatment. To extent traditional orthodontic brackets have been used as attachment devices, they have not been deliberately designed for use in transferring the desired forces between a removable appliance and a given tooth, or for relatively easy removal the appliance from the patient's mouth. Common CTA attachments, in telling contrast, are simply not designed to engage or retain an archwire.

Attachments of the present disclosure combines the optimal practices of the traditional bracket-wire system and more resilient appliance systems (e.g., CTAs and polymeric bands). The attachments include prescribed in/outs, torques and angulations designed utilizing the straight wire methodology for determining the bonding location on a particular tooth of the dental arch. By fixing attachments according to the present disclosure, the most prominent portion of the tray or band for all teeth in the labial direction will be relatively straight (in/out) and flat (torque) at the conclusion of the treatment. The marriage of bracket prescription with attachment placement can help the orthodontist to visualize the treatment outcome with the tray or band on the patient. Patient comfort can be another advantage because of the straightness of the tray and installation of a tray or band on the arch may be made easier with the attachments following the typical tooth angulations.

Attachments of the present disclosure may be used throughout the entire combination treatment, obviating the need to switch between attachments and brackets as the treatment transitions between modalities. The attachments are deliberately designed to ease that transition, as well as the seating of an archwire once the braces dependent treatment in commenced. The attachments may be easily bonded using direct or indirect techniques or may be created on the teeth in situ. The reduced number of bonding steps substantially reduces chair time for both the treating professional and patient.

In one aspect, the present disclosure provides, an orthodontic attachment device comprising an attachment body and a bonding surface underlying the body; wherein the attachment body has the general shape of an inverted frustrum. The attachment device may lack a flared base. The attachment body may a generally trapezoidal cross-sectional shape along either or both of a mesial-distal or occlusal-gingival axis.

In one aspect, a set of orthodontic attachment devices comprising: A first attachment having a first attachment body and a first bonding surface, wherein the first attachment body has a first prescription including at least two defined prescription elements selected from in/out, torque and angulation; and a second attachment having a second attachment body and a second bonding surface, wherein the second attachment body has a second prescription including at least two defined prescription elements selected from in/out, torque and angulation, wherein the first prescription is different from the second prescription.

As used herein, “anterior teeth” includes the central incisors, lateral incisors, canines, and first bicuspids.

As used herein, “posterior teeth” includes the second bicuspid, the first molar, the second molar, and the third molar (if patient still retains wisdom teeth).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a”, “an”, and “the” are not intended to refer to only a singular entity but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

The details of one or more examples of this disclosure are set forth in the accompanying drawings and the description below. Other features, objects, and advantages of this disclosure will be apparent from the description and drawings, and from the claims.

### BRIEF DESCRIPTION OF DRAWINGS

FIG. 1 is a perspective view of a removable dental appliance coupled to a dental arch, according to embodiments of the present disclosure;

FIG. 2 is another perspective view of the removable dental appliance of FIG. 1;

FIG. 3 is a conceptual diagram illustrating a plurality of combination treatment attachments on a dentition of a patient;

FIG. 4 is a perspective view of an orthodontic brace coupled to a dental arch, according to embodiments of the present disclosure;

FIG. 5 is a perspective view of a combination treatment attachment according to embodiments of the present disclosure;

FIG. 6 is a gingival edge view of the attachment of FIG. 5;

FIG. 7 is a mesial side view of the attachment of FIGS. 5 and 6;

FIG. 8 is a facial view of the attachment of FIGS. 5-7;

FIG. 9 is a perspective view of another combination treatment attachment according to embodiments of the present disclosure;

FIG. 10 is a gingival edge view of the attachment of FIG. 9;

FIG. 11 is a mesial side view of the attachment of FIGS. 9 and 10;

FIG. 12 is a facial view of the attachment of FIGS. 9-11;

FIG. 13 is a perspective view of another combination treatment attachment according to embodiments of the present disclosure;

FIG. 14 is a gingival edge view of the attachment of FIG. 13;

FIG. 15 is a mesial side view of the attachment of FIGS. 13 and 14;

FIG. 16 is a facial view of the attachment of FIGS. 13-15;

FIG. 17 is a perspective view of a removable dental appliance coupled to a dental arch, according other embodiments of the present disclosure;

FIG. 18 is another perspective view of the removable dental appliance of FIG. 17;

FIG. 19 is a perspective view of a transfer tray for assisting in the placement of attachments of the present disclosure;

FIG. 20 is a perspective view of an attachment according to embodiments of the present disclosure;

FIG. 21 is a facial view of the attachment of FIG. 20;

FIG. 22 is an occlusal edge view of the attachment of FIGS. 20 and 21; and

FIG. 23 is a mesial side view of the attachment of FIGS. 20-22.

Repeated use of reference characters in the specification and drawings is intended to represent the same or analogous features or elements of the disclosure. It should be understood that numerous other modifications and examples can be devised by those skilled in the art, which fall within the scope and spirit of the principles of the disclosure. The figures may not be drawn to scale.

### Directional Definitions

As used herein:

“Mesial” means in a direction toward the center of the patient's curved dental arch.

“Distal” means in a direction away from the center of the patient's curved dental arch.

“Occlusal” means in a direction toward the outer tips of the patient's teeth.

“Gingival” means in a direction toward the patient's gums or gingiva.

“Facial” means in a direction toward the patient's lips or cheeks.

“Lingual” means in a direction toward the patient's tongue.

### DETAILED DESCRIPTION

The present disclosure generally relates to orthodontic attachments, their preparation, and use. Generally, orthodontic attachments may be bonded to the teeth by a direct bonding procedure or an indirect bonding procedure. In the direct bonding procedure, the appliance is commonly grasped with a pair of tweezers or other hand instrument and placed by the practitioner on the surface of the tooth in its desired location, using a quantity of adhesive to fix the appliance to the tooth. In the indirect bonding procedure, a transfer tray is constructed with wall sections having a shape that matches the configuration of at least part of the patient's dental arch, and orthodontic appliances are releasably connected to the tray at certain, predetermined locations. After an adhesive is applied to the base of each appliance, the tray is placed over the patient's teeth and remains in place until the adhesive has hardened. The tray is then detached from the teeth as well as from the appliances such that the appliances previously connected to the tray are bonded to the respective teeth at their intended, predetermined locations.

The disclosed articles, systems, and techniques include tooth attachments configured for use with common removable appliances, such as CTAs and polymeric arch members, and archwires. The attachments may have a prescribed, preformed shape that is similar to common orthodontic bracket prescriptions. The attachments may include one or more cross-sections having a generally trapezoidal shape. The attachments have an archwire slot that may be partially or fully enclosed, depending on the prescription. The attachments may be directly bonded to the teeth or delivered via a transfer tray (i.e., via indirect bonding).

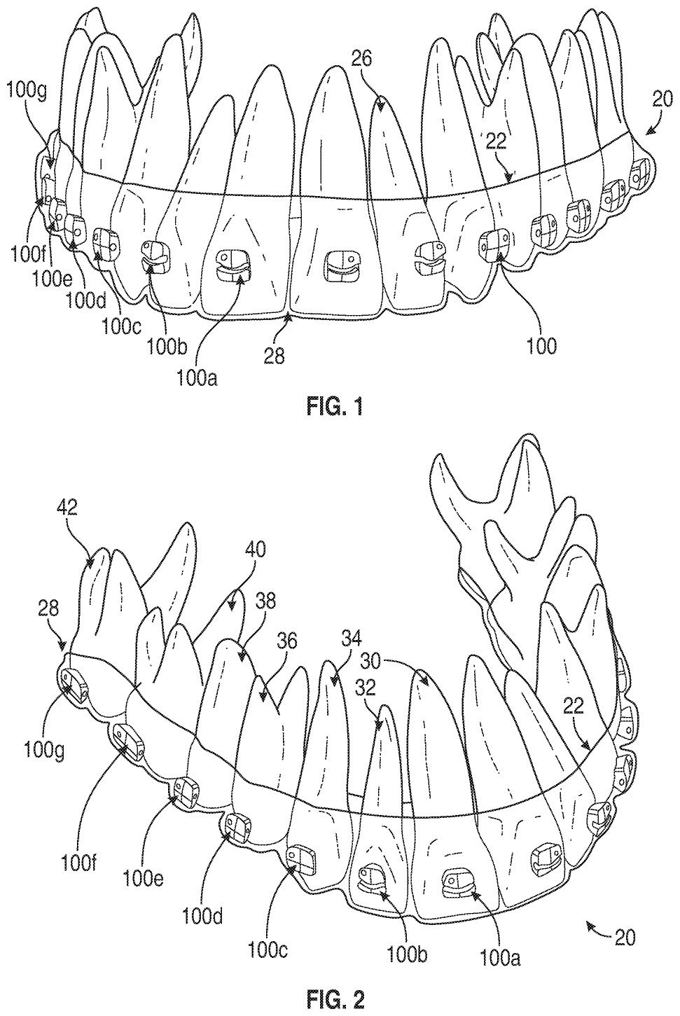

A removable dental appliance constructed according to one embodiment of the present disclosure is illustrated in FIGS. 1-3 and is broadly designated by the numeral 20. In FIG. 1, the illustrated dental arch 28 is an exemplary maxillary or upper dental arch although it should be understood in this regard that the appliance 20 (and all other appliances described herein) may be adapted for use with the mandibular or lower dental arch, as well. Generally, the upper dental arch 28 includes a left quadrant and a right quadrant, each of which has a central incisor tooth 30, a lateral incisor tooth 32, a cuspid tooth 34, a first bicuspid tooth 36, and a second bicuspid tooth 38. In addition, each of the left and right quadrants includes a first molar tooth 40 and a second molar tooth 42. The lower arch (not pictured) includes the other left and right quadrants.

The dental appliance 20 includes an orthodontic tray aligner (i.e., CTA) 22 and a set of orthodontic attachments 100a, 100b, 100c, 100d, 100e, 100f, and 100g. The attachments 100a-100g are each affixed to a respective tooth 26 of an orthodontic patient's dental arch 28. The attachments 100a-100g can be attached to the surface of corresponding tooth using any suitable technique or combination of techniques. For example, the attachments 100a-100g can be bonded to the surface of the tooth using a suitable adhesive or cement. The attachments 100a-g need not be adhesively bonded and may, as an example be welded to an orthodontic band and subsequently secured to a respective tooth using a suitable band cement. The tray aligner 22 includes a plurality of cavities shaped to receive one or more teeth in the lower arch. In some embodiments, in an orthodontic aligner tray at least some of the cavities shaped and configured to apply force to the teeth of the patient to resiliently reposition one or more teeth from one tooth arrangement to a successive tooth arrangement. In the case of a retainer tray, the cavities are shaped and configured to receive and maintain the position of one or more teeth that have previously been aligned.

In particular, the removable dental appliance 20 in each of the left and right quadrants includes a central incisor attachment 100a that is coupled to the central incisor tooth 30, a lateral incisor appliance 100b that is connected to the lateral incisor tooth 32, and a cuspid appliance 100c that is connected to the cuspid tooth 34. The brace 22 also includes in each quadrant a first bicuspid appliance 100d that is coupled to the first bicuspid tooth 36, a second bicuspid appliance 100e that is connected to the second bicuspid tooth 38, a first molar appliance 100f that is connected to the first molar tooth 40 and a second molar appliance 100g that is connected to the second molar tooth 42.

The removable dental appliance 20 of this embodiment and the appliances of other embodiments, unless otherwise indicated, are described herein using a reference frame with the attachment fixed to a labial surface of a tooth. Consequently, terms such as labial, lingual, mesial, distal, occlusal, and gingival used to describe the appliance 20 and its attachments 100a-100g are relative to the chosen reference frame. The embodiments, however, are not limited to the chosen reference frame and descriptive terms, as the appliance 20 may be used on other teeth and in other orientations within the oral cavity. For example, the appliance 20 may also include attachments coupled to the lingual surface of the tooth. Those of ordinary skill in the art will recognize that the descriptive terms used herein may not directly apply when there is a change in reference frame. Nevertheless, the embodiments are intended to be independent of location and orientation within the oral cavity and the relative terms used to describe embodiments of the orthodontic bracket are to merely provide a clear description of the embodiments in the drawings.

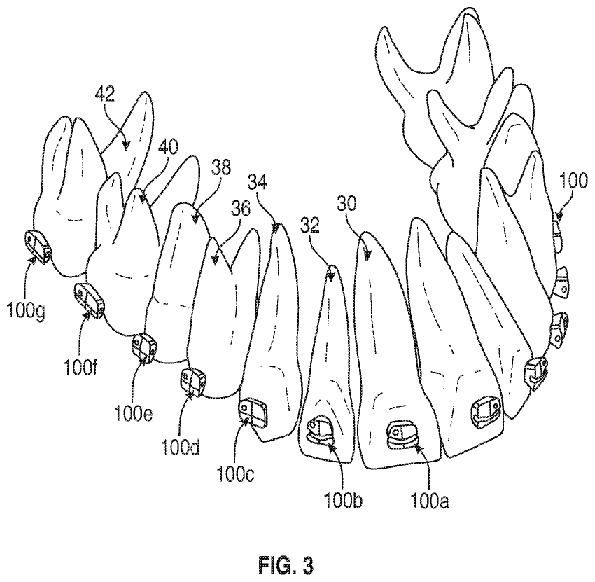

FIG. 3 is an illustration somewhat similar to FIGS. 1 and 2, except that the tray aligner 22 has been removed. As depicted, the attachments 100 are directly bonded to the enamel surface of the patient's teeth 26. Also as depicted, each tooth 26 of the dental arch 28 receives an attachment except the first molar, although alternative arrangements are also possible. For example, the attachments may be attached to all of the teeth 26 in the dental arch 28 except for the molar teeth or may be attached to only certain selected teeth as may be desired by the practitioner or otherwise prescribed according to an orthodontic treatment plan.

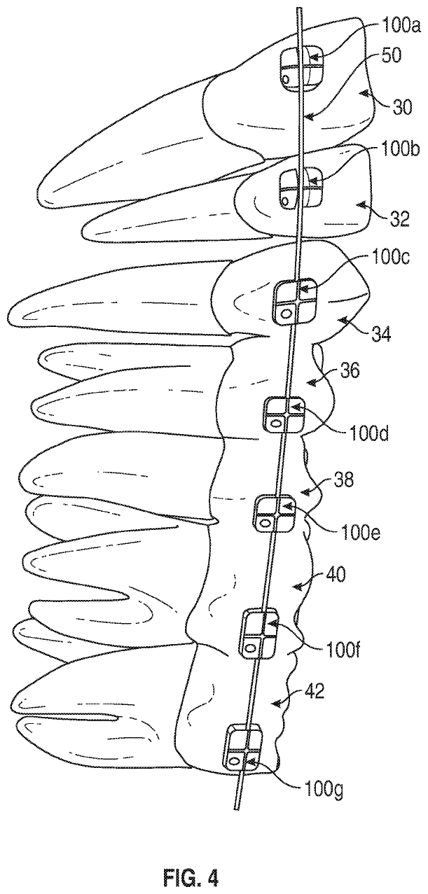

The attachments may advantageously function as brackets for an orthodontic brace, as depicted in FIG. 4. An archwire 50 can be engaged with each of the attachments 100a-100g. Suitable materials for the archwire 50 include, for example, metallic materials such as alloys of nitinol and stainless steel. In plan view, the archwire 50 has an overall, generally “U”-shaped configuration. In the depicted embodiments of FIG. 4, the central and lateral attachments 100a and 100b include partially enclosed archwire slots, while the cuspid and molar attachments 100c-100g include fully enclosed slots. In presently preferred circumstances, at least one anterior attachment in the quadrant includes a partially enclosed slot.

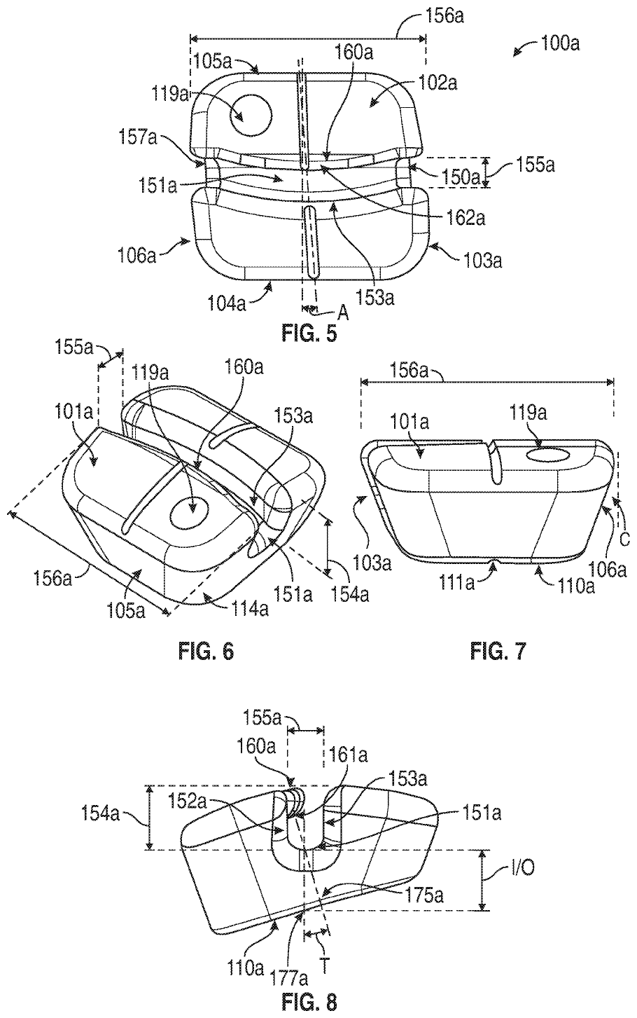

FIGS. 5-8 illustrate an example central attachment appliance 100a including an attachment body 102a and a bonding surface 110a. Attachment body 102a (“body 102”) is configured to be bonded to the teeth to improve force application by a CTA 22, archwire 50, or polymeric arch member (See FIGS. 17-18) to achieve desired tooth movements. Body 102a may be sized such that attachment device 100a is difficult to manipulate, e.g., using a tool such as tweezers. For example, body 102a may have a maximum dimension of 10 mm or less, 8 mm or less, 6 mm or less, 4 mm or less, 3 mm or less, or 2 mm or less; and mm or greater, 0.50 mm or greater, 0.75 mm or greater, 1.00 mm or greater, 1.25 mm or greater, 1.50 mm or greater, 1.75 mm or greater, 2.00 mm or greater, 2.50 mm or greater, 3.00 mm or greater, or 3.50 mm or greater.

A bonding surface 110a of body 102a may be shaped to correspond to a contour of a portion of a tooth of a patient. The bonding surface 110 can be shaped to bond at the facial axis of the clinical crown (“FACC”) of a particular tooth of a particular dental arch. The FACC is defined as the curved line formed by the intersection of the mid-sagittal plane and the facial surface of a given tooth. In contrast to common orthodontic brackets configurations, the bonding surface 110a is not an underlying surface of a distinct base with any flanged portions thereof extending beyond or at least partially surrounding the perimeter of the body 102a. Accordingly, the attachment 100a lacks what is referred to hereafter as a flared base. As depicted, the bonding surface 110a is the underside of the body 102a, defined by the lingual surface of the attachment 100a. In other embodiments not depicted, the attachment 100a (or any of the other attachments described herein) may be provided with a flared bonding base.

The bonding surface 110a may include compound curvature corresponding to the expected convex curvature of a particular tooth of the dental arch, here a left or right central tooth. Corresponding to the contour of the tooth may improve strength of an adhesive bond between body 102a and the tooth, reduce an amount of adhesive required for the bond, or both. In some examples, bonding surface 110a may include etched and/or embossed patterns intended to facilitate more secure bonding. In some examples, a perimeter edge of bonding surface 110a may be smooth, e.g., not etched or embossed, to facilitate removal from a tooth surface at the end of treatment.

The bonding surface 110a can have a tooth facing surface contour that is customized to fit any suitable surface of a tooth. For example, in one or more embodiments, the bonding surface 100a has a tooth-facing surface contour that is customized to fit a labial surface of a given tooth. Having a customized bonding surface 110a can allow the attachment 100a to be configured with a lower profile for patient comfort. Any suitable technique or combination of techniques can be utilized to form customized bondable anchors, e.g., the techniques described in U.S. Pat. No. 10,136,965 (Wiechmann, et al.), and U.S. Patent Publication No. 2005/0277084 (Cinader, Jr., et al.). In one or more embodiments, the bonding surface 110a of one or more attachments 100 can include any suitably shaped surface that is not necessarily customized to fit a particular surface of a tooth, i.e., a “generic” base. In other implementations, the bonding surface 110a may include a fixed, compressible material to assist in filling gaps between the bonding base 110a and the tooth topography. Suitable compressible materials are described, for example, in U.S. Pat. No. 9,539,065 (Cinader, Jr.).

In some embodiments, the appliance 100a includes a frangible web 111a located adjacent the bonding surface 110a that enables the appliance to be conveniently squeeze-debonded by fracturing a frangible web and pivoting the mesial and distal halves of the appliance 100a toward each other. Further options and advantages are described in issued U.S. Pat. No. 5,366,372 (Hansen, et al.).

An archwire slot 150a, having a generally rectilinear configuration, extends in a generally mesial-distal direction across a generally facial-facing surface of the body 102a. Referring particularly to the distal view in FIG. 8, the archwire slot 150a includes a bottom, lingual wall 151a along with gingival and occlusal side walls 152a, 153a. The archwire 50 is received in the archwire slot 150a and typically has at least one cross-sectional dimension that substantially corresponds with at least one of the height 154a and width 155a of the archwire slot 150a. A close correspondence between the dimensions of the archwire and the archwire slot 150a can provide for a precise coupling between the archwire and attachment 100a, giving the treating practitioner a high degree of control over the movement of teeth. It should be appreciated, however, that other archwire geometries can be used that do not closely approximate the dimensions of the slot walls.

The archwire slot 150a can, in certain embodiments of the disclosure, be designed with a 0.018″×0.018″ cross-section dimension, which is smaller than a conventional archwire slot cross-section dimension of 0.018″×0.028″ or 0.022″×0.028″. The smaller slot 150a is intended for working with smaller and flexible round archwires such as 0.012″ D, 0.014″D and 0.016″D. Larger square wires such 0.016″×0.016″ can also be used to provide torqueing moment after teeth are aligned and leveled.

The occlusal wall 153a incorporates a generally concave curvature, relative to the gingival wall 152a, along a path spanning the majority of the mesial-distal slot length 156a. The curvature of the occlusal wall 153a results in the slot 150a having a greater width 155a at the mesial-distal center than at either the mesial or distal edges; the occlusal-gingival width accordingly tapers as an edge is approached from the center of the slot. The curvature of the occlusal wall 153a assists in seating an archwire in the archwire slot 150a once the attachment has been bonded to a central tooth.

It should likewise be appreciated that attachments of the present disclosure may be designed for and used with archwires having any useful cross-sectional dimensions.

A curved slot guard 160a, integral with the gingival side of the body 102a, protrudes over a portion of the slot 150a entrance to partially enclose the slot 150a. The slot guard 160a extends over a section of the slot width 154a and spans at least a substantial portion of the mesial-distal slot length 156a. The guard 160a reduces the buccolabial height 154a of the slot 150a in regions between the bottom wall 151a and a lingual surface 161a of the guard 160a.

The slot guard 160 is curved around an arc having a radius substantially similar to that of the occlusal wall 153a, which allows a wire to be bent around the slot guard 160, seated in the archwire slot 150a, and allowed to straighten. The lingual surface 161a of the guard then tends to prevent a seated archwire 50 from disengaging from the slot 150a. At its apex 162a, the slot guard 160a protrudes beyond the gingival wall 152a at least about 40% of the slot width 155a as measured at the distal edge 157a and no greater than about 150% of the slot width. In other embodiments, the slot guard 160a protrudes beyond the gingival wall 152a at least about 60% of the slot width 155a and no greater than about 120% of the slot width. Allowing the slot guard to protrude too far into the slot risks complications in seating the archwire 50 by, for example, requiring excess bending of the wire or allowing insufficient opening to enter the slot 150a.

In other embodiments not pictured, the slot guard may protrude from the occlusal section of the body, with the gingival wall of the slot having a commensurate curvature.

The attachment 100a (and all attachments described herein) may include a prescription consistent with its use in an orthodontic brace. Examples of well-known prescriptions include those taught by Drs. McLaughlin, Bennett and Trevisi (the “MBT” brand bracket prescription), those taught by Dr. Ron Roth and those taught by Dr. Lawrence F. Andrews. The prescription for any attachment 100a-100g may include one or more prescription elements including in/out, torque, and angulation. The description of each prescription element value that follows with respect to the attachment 100a is equally valid and applicable to attachments 100b-100g. In FIG. 8, the in-out dimension of the attachment 100a is designated I/O and represents the buccolingual height of the attachment 100a as measured between the bottom wall 151a of the slot 150a and the bonding surface 110a along a reference axis that is perpendicular to the bottom wall 151a and passes through the mesial-distal and occlusal-gingival center of the appliance body 102a.

Tooth angulation can be defined according to the teachings of Dr. Lawrence F. Andrews as the mesiodistal cant of the FACC relative to a line perpendicular to the occlusal plane (see, e.g., Straight Wire, The Concept and Appliance, by Lawrence F. Andrews, (L. A. Wells Co., (C) 1989)). Attachment 100a angulation “A” may be defined as the particular angular orientation of the body 102a of the appliance relative to an imaginary vertical line “L” representative of the long axis of a tooth and extending through the mesial distal center of the bracket.

Tooth torque may be defined as the buccolabial-lingual cant of the FACC when measured from a line perpendicular to the occlusal plane. Consequently, attachment torque may be defined as the orientation of the archwire slot relative to the base of the attachment such that the desired tooth torque is attained. Bracket torque is typically provided via a specified angle of the archwire passage, i.e., “torque in the slot”, or an angle is formed in the tooth mounting surface of a bracket, i.e., “torque in the base”. Under either configuration, the attachment 100a can be provided with a certain torque that is designated by the letter “T” in FIG. 8. The torque, or angle T, is equivalent to the angle between a reference plane 175a perpendicular to the bonding surface 110a of the bonding base and a reference line 177a. The reference line 177a extends in an occlusal-gingival direction and intersect to the bonding surface 110a at a point that is located in a lingual direction beneath the mesial-distal center and occlusal-gingival center of the archwire slot 150a.

Table I sets out the preferred values according to the present disclosure for in/out, torque and angulation of attachments 100a-100f for teeth of the upper or maxillary arch. Table II is a table similar to Table I except that Table II is directed to the lower or mandibular arch.

TABLE I
Maxillary Arch

| | Central | Lateral | Cuspid | 1^{st} Bicuspid | 2^{nd} Bicuspid | 1^{st} Molar | 2^{nd} Molar |
|---|---|---|---|---|---|---|---|
| In/out, inch | 0.026 | 0.035 | 0.021 | 0.029 | 0.029 | 0.03 | 0.03 |
| Torque, | 17 | 10 | −7, +7 | −7 | −7 | −14 | −14 |
| degrees | | | or 0 | | | | |
| Angulation, | 4 | 8 | 8 | 0 | 0 | 0 | 0 |
| degrees | | | | | | | |

TABLE II
Mandibular Arch

| | Central | Lateral | Cuspid | 1^{st} Bicuspid | 2^{nd} Bicuspid | 1^{st} Molar | 2^{nd} Molar |
|---|---|---|---|---|---|---|---|
| In/out, inch | 0.045 | 0.045 | 0.020 | 0.030 | 0.034 | 0.030 | 0.030 |
| torque, | −6 | −6 | −6, +6 | −12 | −17 | −20 | −15 |
| degrees | | | or 0 | | | | |
| angulation, | 0 | 0 | 3 | 2 | 2 | 0 | 0 |
| degrees | | | | | | | |

A suite of attachments 100a-100g having prescribed values for I/O, torque, and angulation can allow a practitioner to design treatment according to common bracket placement principals, including the straight wire technique described above. Since the attachments are designed to have the prescribed in/outs, torques and angulations, the most prominent portion of the tray or arch member for all teeth in the labial direction will be relatively straight (in/out) and flat (torque) at the conclusion of the treatment. This can assist the orthodontist or other treating professional to visualize the treatment outcome with the treatment apparatus on the patient. Moreover, insertion of the tray or arch member can be made easier since the attachments follow the angulations of teeth. Furthermore, the prescription nature of the appliance allows for bulk manufacturing of attachments if desired, rather than custom or on demand manufacturing.

The mesial, occlusal, gingival, and distal facing side surfaces 103a, 104a, 105a, 106a may include any suitable shape that is configured to transfer a force from a resilient appliance to the tooth, retain the resilient appliance on the tooth, or both. For example, one or more portions of the side surfaces 103a, 104a, 105a, 10a6 may be hemispherical, rectilinear, curvilinear, or irregular in shape. In some examples, any one of the side surfaces 103a, 104a, 105a, 106a may include one or more surface features, including, but not limited to, one or more tapers, undercuts, overhangs, recesses, negative drafts, or other features configured to engage or otherwise interact with a CTA, arch member, or a transfer tray. Tapered surfaces, for example, may reduce interference with the tongue, cheeks, and/or lips to improve comfort for the patient and/or reduce visibility of attachment body 102a when bonded to the teeth.

As depicted, the central attachment 100a includes tapered surfaces on each of the mesial, distal, occlusal and gingival side surfaces 103a, 104a, 105a, 106a. The tapering gives the attachment body 102a the overall shape of an inverted frustum, with the facial surface 101a as the base. Each tapered side surface 103a, 104a, 105a, 106a presents a continuous taper between the perimeter edge 109a of the facial surface 101a and an edge 111a of the bonding surface 110a. The tapering provides a continuous undercut beneath the facial surface 101a and a generally trapezoidal cross-sectional shape when viewed from both an occlusal-gingival and mesial-distal direction. (See FIGS. 7 and 8). In other embodiments, only the mesial and distal surfaces include a taper. In other embodiment, only the occlusal and gingival side surfaces include a taper. In other embodiments, only the occlusal and mesial; or gingival and mesial; or occlusal and distal; or gingival and distal. In other embodiments, only one of the mesial, occlusal, gingival, or distal side surfaces include a taper.

Each side surface is inclined relative to a plane tangent an edge of the facial surface at an acute draft angle “C”. In some embodiments, the angle C is at least about 30 degrees, at least about 25 degrees, at least about 20 degrees, at least about 15 degrees. In presently preferred embodiments, the draft angle “C” is greater than about 1 degrees, greater than about 2 degrees, greater than about 3 degrees, no greater than about 4 degrees, no greater than about 5 degrees. In presently preferred circumstances, the angle C is between about 30 and about 1 degrees. The angle C can be the same or different between any two side surfaces 103a, 104a, 105a, 106a.

The transition 114a between any two adjacent side surfaces (e.g., between mesial surface 103a and gingival surface 106a) is preferably arcuate with a defined curvature, such that body 102a lacks sharp edges. The transition 114a can be a variety of radius sizes depending on the overall size of the body 102a. Moreover, the side surfaces 103a, 104a, 105a, 106a typically lack additional recesses, crevices, protrusions, or other changes in topography between the bonding surface 110a and the facial surface 101a.

The facial surface 101a can include indicia identifying the attachment prescription. The indicia may include text, symbols, coloring, scribe lines, or the like. The indicia may also identify the desired orientation of the attachment once bonded to the tooth, such as a gingival marker 119a. The indicia may also include at least one of mesial-distally and occuso-gingivally extending scribe lines 118a.

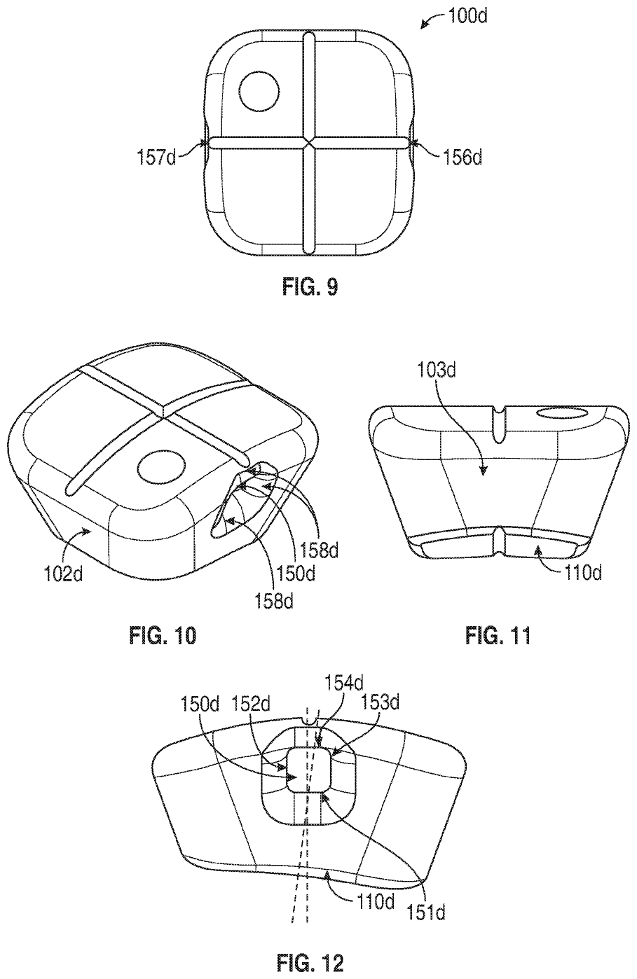

FIGS. 9-14 illustrate another example attachment appliance 100d including an attachment body 102d and a bonding surface 110d. Appliance 100d has a reduced torque T, zero angulation A and greater “in-out” I/O dimension than appliance 100a. The resulting appliance is well suited for bonding to a patient's first or second bicuspid tooth. It is to be understood that many other aspects of attachment 100d may have similar form and function to those described in attachment 100a and these need not be repeated.

An elongated archwire passage 150d extends across and through the body 102d in a generally mesial-distal direction. The archwire passage 150d is defined by an occlusal wall 153d, a gingival wall 152d, a buccolabial wall 154d, as well as a tooth-facing or lingual wall 151d, thus representing a fully enclosed passage. The passage 150d includes a mesial entry 156d and a distal entry 157d on either end of the passage 150d, with an interior section extending therebetween. The interior section has a generally rectangular shape when viewed in a longitudinally transverse reference plane (See FIG. 12) although circular, square, ovular, and other quadrilateral shapes are also possible. In yet other embodiments, the archwire passage 150d may lack a buccolabial wall 154d and may instead include a slot guard for partial enclosure similar to attachment 100a.

Both the mesial and distal entries 156d, 157d feature tapered, convex portions 158d of the walls 151d, 152d, 153d, 154d to present a funneled entry. The passage entries 156d, 157d can include at least two, in some embodiments at least three, and in the depicted embodiment four convex wall portions 158d. In presently preferred embodiments, the convex wall portions 158d provide a taper having at least one section of continuous curvature such that the passage 150d lacks or minimizes a deliberate demarcation between the entry 156d, 157d and passage interior. In this way, the entrance and exit to the archwire slot 150d is wider, allowing for easier threading of the archwire 50 through the archwire passage 150d. By eliminating or minimizing the transition between mesial and distal wall sections of the slot, any binding friction or potentially impeding stop surfaces between the archwire 50 and the passage 150d are reduced, thereby facilitating prompt insertion of the archwire 50.

The depicted mesial entry 156d includes convex wall portions 158d providing a continuously curved taper between the mesial entry 156d and the interior of the passage 150d. In other embodiments, the convex wall portions 158d can include a compound curvature, much like the base 102d. In such embodiments, a first radius of curvature at and adjacent the entry 156d, 157d is typically greater than a second radius of curvature more adjacent the passage interior section. In implementations with compound curvature, the convex wall portion 158d may present a continuously curved taper or may include a flat land area. Those skilled in the art will appreciate that other dimensions and relationships between the convex wall portions are possible and can be tailored to a desired mesial-distal length and buccal height of the passage 150d.

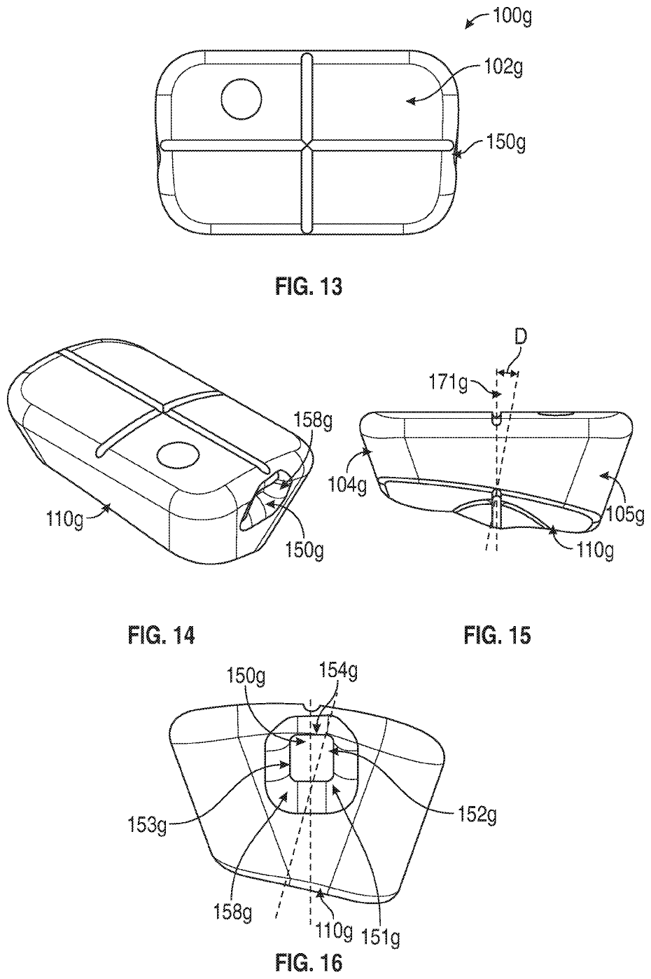

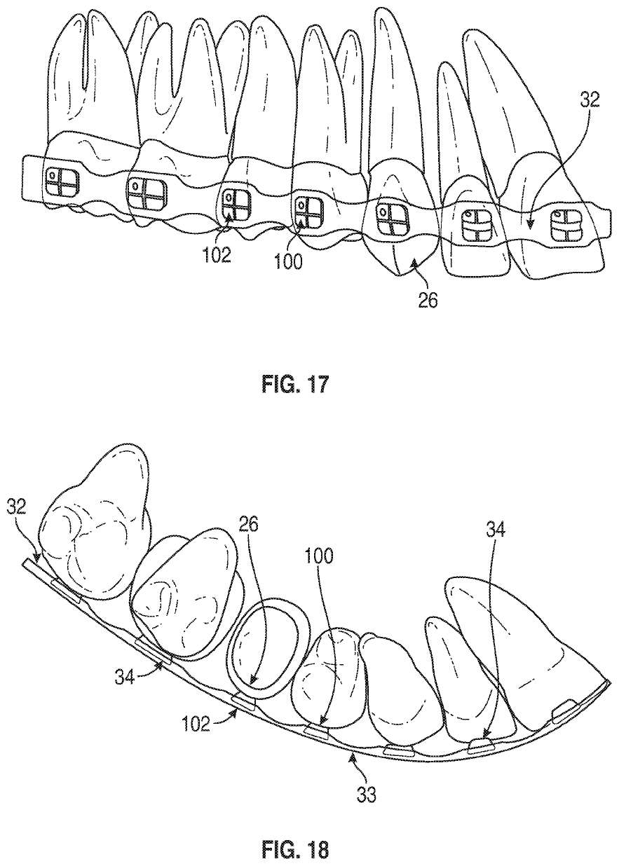

FIGS. 13-16 illustrate another example attachment appliance 100g including an attachment body 102g, a bonding surface 110g, and an enclosed archwire passage 150g. Appliance 100g is similar to appliance 100d but has an increased mesial-distal width and a distal offset in the bonding surface 110g. The distal offset tilts the bonding surface 102g at angle “D” relative to an axis 171g extending perpendicular to the bottom wall 151g and through the mesial distal center of the attachment body 102g. The distal offset better conforms the bonding surface 110g to typical molar tooth topography. The distal offset also results in a greater buccolabial height of the attachment 100g at the distal edge 105g than at the mesial edge 104g. The resulting appliance 100g is well suited for bonding to a patient's first and second molar teeth (in this way, appliance 100g and 100f are of similar utility and construction). It is to be understood that many other aspects of attachment 100g may have similar form and function to those described in attachments 100a and 100d and these need not be repeated.

The attachments 100a-g are designed for ease of archwire insertion during a braces phase of combination treatment. Once the attachments 100a-g are bonded to the teeth according to desired placement and/or the removable appliance is removed from the mouth depending to phase of treatment, the distal ends of a generally u-shaped, planar archwire 50 may be threaded through the enclosed archwire passages 150f-150g on at least the molar attachments 100f-100g and typically also through passage 150d-150e on the bicuspid attachments 100d-100e. The anterior, proximal apex of the archwire can be bent around any slot guards, and the archwire subsequently seated in all archwire passages 150a-150g in both quadrants. If desired, the archwire 50 may be ligated to the molar attachments 100f-100g via conventional mechanisms such as elastomeric O-rings or wires.

To remove the archwire at the conclusion of treatment or a given treatment phase, the archwire 50 may be bent around the slot guard(s) and unseated from the anterior attachments. The archwire 50 may then be removed from the remaining attachments by drawing the distal ends out of the enclosed passages in a generally mesial direction.

FIGS. 17 and 18 depict another illustration of another removable dental appliance including attachments of the present disclosure, except that the treatment apparatus includes a polymeric arch member 32 rather than an aligner tray. The arch member 32 may be made of a single layer of material having sufficient resiliency to receive the attachments 100a-g or a multi-component material comprising multiple layers. The arch member 32 includes a series of receptacles that are spaced apart from each other along the length of the arch member 32. Each of the receptacles receives the body 102 of a respective attachment appliance 100a-g. Each of the receptacles has a configuration adapted to releasably receive the body 102a-g in e.g., snap-fit relation. Consequently, the arch member 32 can be disconnected from the attachments 100a-f when desired.

The polymeric arch member 32 can include any suitable cross-sectional geometry, e.g., shape, area, orientation, etc. The cross-sectional geometry can be constant or vary along a length of the arch member 32. The cross-sectional shape (e.g., triangular, rectangular, elliptical, etc.), of the arch member can be uniform along a length of the body, or in other implementations the shape may vary. Further, the polymeric arch member 32 can include a uniform cross-sectional area or a cross-sectional area that varies along the length of the arch. As depicted, the arch member 32 has a buccolabial surface 33 defining a continuous arc about the dental arch. As depicted, the buccolabial surface 33 exist in a plane substantially perpendicular to the occlusal plane of the arch. At the very least, the buccolabial surface will be substantially parallel to a plane defined by the facial surfaces of the attachments 100a-g. The region of the arch member 32 between any two adjacent attachments 100a-g follows the same curvature as the arch member adjacent the receptacles. The inner surface of the tray may be spaced facially from the labial surfaces of the teeth.

The exemplary receptacles surround the body 102a-g of each attachment 100a-g along the each of the facial occlusal, mesial, gingival and distal sides thereof. However, other constructions are also possible. For example, the receptacles may extend completely through the arch member 32 such that the receptacles comprise apertures and facial surfaces of the attachments 100a-g are exposed when viewing the apparatus 20 towards a lingual direction. In certain circumstances, the receptacle may extend over only a portion of the exterior surfaces of the attachment body 102a-g to effectuate desired movement, a configuration that may ease disengagement of the arch member. Both the receptacles and the attachments bodies 102a-g have a configuration that permits effecting tooth movement along or about multiple axes as desired. To this end, the attachment bodies 102a-g and the receptacles 38 preferably have complimentary polygonal shapes, matching key and keyway shapes or other interlocking configurations that facilitate transmitting the desired forces from the arch member 32 to the attachment 100a-g and ultimately to the underlying teeth.

Typically, the arch member 32 has a geometry when relaxed that generally corresponds to the geometry necessary to move the teeth to the desired in positions. When the arch member 32 is placed on the attachments 100a-g, however, the geometry of the arch member 32 is changed to a temporary shape corresponding to the shape of the tooth arrangement prior to reaching the desired arrangement, such as the current tooth arrangement. The resilient properties of the polymeric material function to exert forces on the teeth 26 as necessary to shift the teeth to the desired arrangement.

Preferably, the arch member 32 is connected to the attachments 100a-g such that the arch member 32 may exert forces on the attachments 100a-g and hence on the underlying teeth 26 in a number of different directions. For example, the arch member 32 can exert forces as may be needed to move the attachments 100a-g with six degrees of freedom in either or both translation and rotation with respect to three mutually perpendicular reference axes. As a result, the teeth 26 may be subjected to tipping, torquing or angulation movements as desired.

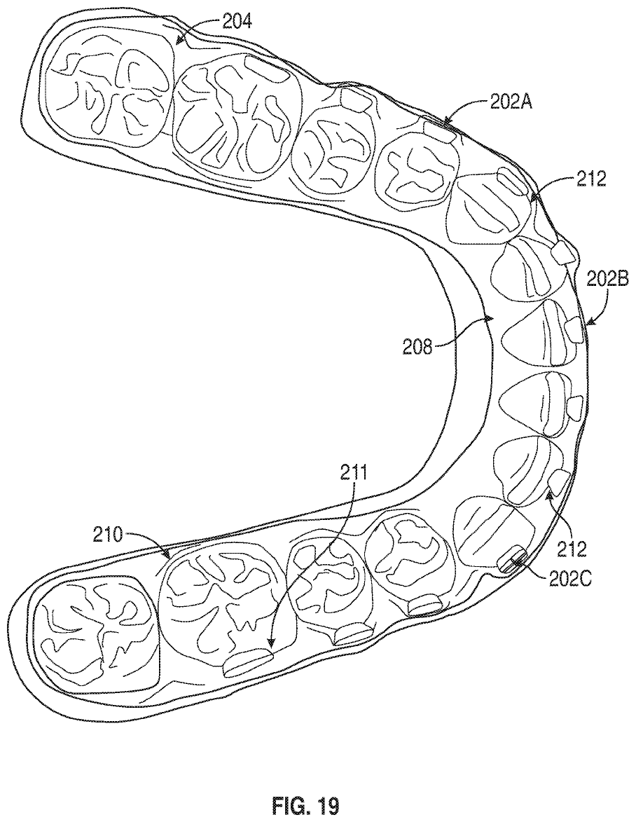

FIG. 19 is a conceptual diagram illustrating an example orthodontic system 200 including a plurality of attachments 202A, 202B, and 202C (collectively, attachments 202) and a transfer tray 204 configured to receive attachments 202. In some examples, orthodontic system 200 defines a kit. Attachments 202 may be the same as or substantially similar to any attachment 100a-100g or variation thereof contemplated above.

Transfer tray 204 is configured to receive attachments 202. Transfer tray 204 includes a body 208 defining a plurality of cavities 210 (shells 210). Each respective shell of shells 210 is configured to receive an outer surface of a respective tooth. In this way, transfer tray is configured to align with the dentition of a patient. Each shell of shells 210 that is configured to receive a respective attachment of attachments 202, defines a respective recess (collectively, shell recesses 212) within shells 210 that is shaped to receive the respective attachment of attachments 202. For example, an interior surface 211 of shells 210 may define recesses 212. In some examples, shell recesses 212 may include a feature, such as an undercut or a protrusion, that is configured to engage with a corresponding feature on an attachment 202. For example, attachment body 102 may define a plurality of undercuts (e.g., tapered surface 103 and 105) and a surface of shell recesses 212 may define a protrusion configured to engage undercut. In this way, corresponding features on a respective attachment and shell recess may improve a security of attachments 202 while at least one of placing a plurality of attachments 202 into transfer tray 204, applying adhesive to bonding surface of attachments 202, or manipulating transfer tray 204 to position transfer tray 204 in the mouth of patient.

After positioning each respective attachment of attachments 202 in a respective shell recess of shell recesses 212, adhesive may be applied to bonding surface of each attachments 202. In some examples, dental adhesive used to bond attachments 202 to teeth 302 may include a light-cure adhesive, a chemical cure adhesive, a dual cure adhesive, 3M RELYX Ultimate Adhesive Resin Cement available from 3M Company (St. Paul, Minnesota), APC Flash-Free adhesive available from 3M Company (St. Paul, Minnesota), or the like. The adhesive may be selected for compatibility with the material used to fabricate the attachment body 102 to securely bond attachments 202 onto teeth. In some examples, shell recesses 212 may be shaped to position bonding surface 106 of attachments 202 relative to interior surface 211 of shells 210 to form a pocket. The pocket may include a selected depth, e.g., relative to interior surface 211, to retain a selected amount of adhesive for bonding attachments 202 to the teeth of the patient. In this way, the amount of adhesive may be controlled to reduce excessive adhesive use, which may result in flashing that must be removed, and/or to reduce insufficient adhesive use, which may compromise bonding strength.

After application of adhesive to attachments 202, transfer tray 204 may be positioned on the teeth of a patient. Then, in examples in which the dental adhesive includes a light cure adhesive, the clinician may direct a selected wavelength of radiation, e.g., actinic radiation, toward one or more of attachments 202 to cause a light-activating resin to set, thereby bonding attachments 202 to the tooth surface. In other examples, the clinician may use an activator or other means to initiate curing of the adhesive immediately before positioning transfer tray 204 of teeth or while transfer tray 204 is positioned on teeth.

The attachments of the present disclosure may be made of an aesthetic material such as a material that is translucent or transparent to light in the visible wavelengths. As another option, the attachments have a color that matches the color of the patient's adjacent dentition. If the attachment(s) are made of a transparent or translucent material, the material preferably transmits sufficient light to enable the color of the patient's underlying tooth to be visible through the front or labial side of the attachment.

The attachments of the present disclosure may be made of metal (such as alloys of stainless steel or other metallic materials), ceramic materials (including monocrystalline and polycrystalline light-transmitting ceramics) and polymeric materials (such as fiber-reinforced polycarbonate). Suitable ceramic materials are described, for example, in U.S. Pat. No. 6,648,638 (Castro et al.). Further, attachments may be formed entirely from a curable composite dental material, such as TRANSBOND brand light cure adhesive (available from 3M Company, St. Paul, MN), and cured in vivo on the patient's teeth using techniques such as those described in U.S. Patent Application Publication No. 2007/0031774 (Cinader, Jr., et al.). In certain presently preferred circumstances, the attachments integrally made as a unitary component by a metal injection molding or as part of an additive manufacturing process. Suitable materials for use in additive manufacturing of the attachment may include, but are not limited to, materials described in International PCT Publications WO 2020/104873 (Chakraborty et al.), WO 2019/048963 (Parkar et al.), WO 2018/231583 (Hellmann et al.), WO 2016/191534 (Mayr et a.), WO 2016/191162 (Mayr et a.), and WO 2014/078537 (Sun et al.). Other material iterations and combinations are also possible.

In some examples, the methods of the present disclosure may include a three-dimensional (3D) printing step in the creation of the attachment, the transfer tray, CTA, polymeric band, or any combination thereof. Three-dimensional printing may include, for example, forming the article from a plurality of layers of a photopolymerizable material described herein by selectively curing the photopolymerizable material in a layer-by-layer manner. In some examples, additive manufactured article may include a plurality of materials bonded to each other. The layers of the photopolymerizable material can be deposited according to an image of the three-dimensional article in a computer readable format. For example, the photopolymerizable material may be deposited according to preselected computer aided design (CAD) parameters (e.g., a data file). In some examples, the photopolymerizable material is cured using actinic radiation, such as UV radiation, e-beam radiation, visible radiation, or combinations thereof.

The foregoing techniques can be repeated a selected number of times to provide the 3D article. For example, in some cases, this process can be repeated “n” number of times. Further, it is to be understood that one or more steps of a method described herein, such as a step of selectively applying energy to a layer of photopolymerizable composition, can be carried out according to an image of the 3D article in a computer-readable format. Suitable stereolithography printers include the Viper Pro SLA, available from 3D Systems, Rock Hill, South Carolina; the Asiga PICO PLUS 39, available from Asiga USA, Anaheim Hills, California; the D30, available from Rapid Shape, Heimsheim, Germany; and the Moonray, available from SprintRay, Los Angeles, California.

Other techniques for three-dimensional manufacturing may be suitably adapted to the techniques described herein. More generally, three-dimensional fabrication techniques continue to become available and may be adapted to use with photopolymerizable compositions described herein, provided they offer compatible fabrication viscosities and resolutions for the specified article properties, for instance continuous additive manufacturing in which a build plate is (essentially) continuously moved through a vat of photopolymerizable material. In certain examples, an apparatus adapted to be used in a continuous mode may be employed, such as an apparatus commercially available from Carbon 3D, Inc. (Redwood City, CA), for instance as described in U.S. Pat. Nos. 9,205,601 and 9,360,757 (both to DeSimone et al.). For example, in any method described above, selective curing of a photopolymerizable material includes continuous photopolymerization of at least one of the first portion of the article or the second portion of the article. Further details of methods for additive manufacturing may be found in co-owned application U.S. Provisional Application No. 62/954,278, filed Dec. 27, 2019, “Preformed Orthodontic Aligner Attachments”.

The present disclosure provides a variety of methods for making and using the attachments of the present disclosure. In one method, a pre-existing set of attachments is directly bonded to teeth using a placement guide, prescription, or the like. Typically, in such methods, the attachment is bonded to the FA point of the requisite tooth. Direct bonding can include placing a hardenable adhesive onto bonding surfaces of attachments. In some examples, the light-cure adhesive could be placed on the attachments. In some examples, other dental adhesives may be used, and the technique may include proper preparation and use of those adhesives (e.g., mixing of two part adhesives, application of curing agent, or the like).

In other embodiments, the attachments are secured to the teeth using digital (i.e., virtual) methods. The digitally enabled methods typically include receiving a digital representation of 3D tooth structure of a patient. This generally involves creating a representation of the patient's teeth and gums, and may involve taking wax bites, using impression materials, casting, direct contact scanning, x-ray imaging, tomographic imaging, sonographic imaging, and other techniques for obtaining information about the position and structure of the teeth, jaws, gums and other orthodontically relevant tissue. A digital data set can be derived from this data that represents a current arrangement of the patient's teeth and other tissues. A virtual model of the dentition may then be re-constructed based on the digital data. Data representing an article may be generated using computer modeling, such as computer aided design (CAD) data. Image data representing the article design can be exported in STL format, or in any other suitable computer processable format, to the additive manufacturing equipment. Scanning methods to scan a three-dimensional object may also be employed to create the data representing the article. One example technique for acquiring the data is digital scanning. Any other suitable scanning technique may be used for scanning an article, including X-ray radiography, laser scanning, computed tomography (CT), magnetic resonance imaging (MRI), and ultrasound imaging. Other possible scanning methods are described, e.g., in U.S. Patent Application Publication No. 2007/0031791 (Cinader, Jr., et al.). The initial digital data set, which may include both raw data from scanning operations and data representing articles derived from the raw data, can be processed to segment an article design from any surrounding structures (e.g., a support for the article).

Often, machine-readable media are provided as part of a computing device. The computing device may have one or more processors, volatile memory (RAM), a device for reading machine-readable media, and input/output devices, such as a display, a keyboard, and a pointing device. Further, a computing device may also include other software, firmware, or combinations thereof, such as an operating system and other application software. A computing device may be, for example, a workstation, a laptop, a tablet, a smart phone, a personal digital assistant (PDA), a server, a mainframe or any other general-purpose or application-specific computing device. A computing device may read executable software instructions from a computer-readable medium (such as a hard drive, a CD-ROM, or a computer memory), or may receive instructions from another source logically connected to computer, such as another networked computer.

Once a digital representation is acquired, the digitally enabled methods may progress to determining a treatment plan including targeted tooth positions and locations of attachments. For example, computing device executing 3D modeling software may render a resultant digital representation of the tooth structure, including the occlusal surface as well as the root structure of the patient's dental arch. Modeling software provides a user interface (e.g., a display, keyboard, and mouse) that allows the practitioner to manipulate digital representations of the teeth in 3D space relative to the digital representation of the dental arch of the patient. By interacting with the computer system, the practitioner generates treatment information, such as by selecting indications of the final positions of individual teeth of the patient, duration of a respective stage of treatment, or number of treatment stages, the direction or magnitude of forces on the teeth of the patient during a stage of treatment, or the like. For example, the final positions of individual teeth of the patient, duration of a respective stage of treatment, or number of treatment stages may affect the direction or magnitude of forces on the teeth of the patient at each stage of treatment by each removable dental appliance of the set of removable dental appliances. In some examples, orthodontic attachments may be used during at least one, but fewer than all stages of treatment. In some examples, the movements to be achieved, the forces applied, and the engagement of each tooth by each removable dental appliance of the set of removable dental appliances may be determined by selecting the dimensions, shapes, and positions of the orthodontic attachments and/or shells of a removable dental appliance. In this way, updating a database with diagnostic and treatment information may include determining or selecting by a clinician, a technician, or automatically by a computer the dimensions, shapes, and positions of the attachments and/or shells of each of removable dental appliance of the set of removable dental appliances to result in the desired movement of the teeth of the patient. In some examples, the technique optionally includes reviewing, e.g., by a dentist, clinician, or other technician, the treatment plan (1506). Systems and methods for generating a treatment plan incorporating CTAs or polymeric arch members can be found, for example, in U.S. Pat. No. 7,435,083 (Chisti, et al.), U.S. Pat. No. 7,134,874 (Chisti, et al.), U.S. Pat. No. 10,307,221 (Cinader, Jr.), U.S. Pat. No. 9,259,295 (Raby et al.); International Patent Publication No. WO2020/208559 (Raby et al.); and US Patent Publication No. 2005/0277084 (Lai et al). In some implementations, the desired final positions of the teeth may be determined by the placement and/or orientation of the attachments.

The digital data may be “cleansed” by removing any data points that represent clear error. For example, files in STL format representing a tooth surface that include a data point significantly outside the normal expected geometrical relationship of adjacent data points could be fixed by STL-handling software to remove the erroneous data point. In addition, tooth data points that are missing could be added by STL-handling software to create realistic, smoothly curved tooth shapes. Alternatively, or in addition to, the data cleansing may be carried out on the data file before conversion of the data to an STL file. As an additional option, data may also be obtained of hidden features of the patient, such as the roots of the patient's teeth and the jaw structure. For example, CT scanning techniques may be used to obtain data representative of the patient's entire tooth structure including the roots. The data obtained by CT scanning may then be “stitched together” with other data obtained by scanning the crowns of the patient's teeth with another scanning technique to provide a more comprehensive virtual representation. Dentition surfaces may be segmented to produce one or more discrete, movable 3D tooth object models representing individual teeth. The tooth models may also be separated from the gingiva into separate objects. Segmentation allows a user to characterize and manipulate the teeth arrangement as a set of individual objects. Advantageously, the computer may derive diagnostic information such as arch length, bite setting, interstitial spacing between adjacent teeth, and American Board of Orthodontics (ABO) objective grading from these models.

A tooth coordinate system, defined by coordinate axes, can be defined for each discrete tooth surface in the virtual dental arch. The coordinate system may include a mesial-distal axis, a buccolabial-lingual axis, and an occlusal gingival axis for each tooth, with each axis computed as perpendicular to the other two axes. The coordinate system may be defined using computed or selected landmarks. Alternatively, the coordinate system may be created by defining a point on a virtual tooth, receiving axis input data that defines first and second axes associated with the virtual tooth, computing a substantially normal vector for a portion of the tooth surface surrounding the point, and computing the tooth coordinate system based on the axis input and the computed vector, Such methods, and well as other exemplary methods for creating tooth coordinate systems, are exemplified in U.S. Pat. No. 9,622,835 (Raby et al.). The tooth coordinate system allows for various modifications to one or more virtual teeth associated with the coordinate system. Aspects that may be adjusted or modified for each tooth include: torque, tip, 1st order rotation, mesial-distal movement (with or without interproximal reduction (IPR)), occlusal-gingival translation, and buccolabial-lingual translation. Each of these aspects relate to movement in one of the six degrees of freedom defined by the coordinate axes of the respective tooth surface. Such modification also includes the positioning and/or attachment of a virtual attachment or attachment analog to a tooth.

One or both of the occlusal and midsagittal planes of the dentition may be specified for the virtual model. The occlusal plane is an imaginary surface that passes through the occlusion of the teeth and is generally approximated by a plane. The midsagittal plane is an imaginary plane passing longitudinally through the middle of the dental arch, dividing it into left and right halves. An initial approximation of the occlusal plane may be based on the shapes or coordinate systems of some or all of the tooth surfaces belonging to an individual arch of the dentition. For example, the occlusal plane may be defined by identifying three points that tangentially contact a plane superimposed on the dentition. For a given dental arch, the three points generally include at least one contact point from a left molar, one contact point from a right molar, and one contact point from a central or lateral tooth. In another embodiment, the occlusal plane is defined as a best-fit plane to the points representing the origins of the tooth coordinate systems, as previously defined. In effect, this plane represents the average of these origins, which are generally positioned at the incisal edges, single cusp tips, or buccal cusp tips of the teeth. The occlusal plane may also be used to calculate and define the vertical axis of the model.

Similarly, the midsagittal plane may be derived based on the shape of the archform according to the coordinate systems of the tooth surfaces of the dentition. Manual adjustments of the occlusal and midsagittal planes to the locations and/or orientations relative to the dentition surface can be made as desired.

Optionally, and once the initial data set is processed and before attachments are placed on the virtual arch, the desired positions of the teeth in the patient's dental arch may be determined. Desired final positions of the teeth can be received, e.g., from a practitioner in the form of a descriptive prescription, can be calculated using orthodontic prescriptions, or can be extrapolated computationally from a clinical prescription. With a specification of the desired final positions of the teeth and a digital representation of the teeth themselves, the final position and surface geometry of each tooth can be specified to form a complete model of the teeth at the desired end of treatment or treatment stage. The result of this step is a set of digital data structures that represents a desired and/or orthodontically correct repositioning of the modeled teeth relative to presumed-stable tissue.

The method of the present disclosure may also include identifying a set of physical tooth attachments to effectuate the treatment plan. The identifying step may include the selection of pre-manufactured attachments based on prescription (e.g., in/out, torque, angulation). The identifying step may include manufacturing, based on the determined unique digital attachments model for each tooth, a set of the tooth attachments of the present disclosure. As discussed above, manufacturing the tooth attachments may include three-dimensional printing. In other example, manufacturing the attachments may include other methods, such as, for example, injection molding or subtractive manufacturing (e.g., milling) In some examples, the providing step involves acquiring a set of attachments from pre-existing inventory.

The methods of the present disclosure can also include modifying the digital tooth data to add attachment analogs to teeth at each location where attachment is placed and saving digital models of maloccluded tooth arches with added attachment analogs. As discussed above, a transfer tray includes shells configured to receive a selected number of teeth and recesses (e.g., pockets) within selected shells to receive an attachment body. The methods optionally include manufacturing positive mockups of maloccluded tooth arches with added attachment analogs, as described in International Patent Publication No. IB2020/058481 (Dufour et al.). Manufacturing the models of maloccluded tooth arches with added attachment analogs may include three-dimensional printing. In other example, manufacturing the models of maloccluded tooth arches with added attachment analogs may include other manufacturing methods, such as, for example, injection molding or subtractive manufacturing (e.g., milling).

A variety of treatment planning systems exist which allow for designing and/or placing virtual appliances relative to a virtual dental arch with computer aid. Such systems are, for example, described in U.S. Pat. No. 7,210,929 (Raby et al.), U.S. Pat. No. 7,811,087 (Wiechmann et al.), and U.S. Pat. No. 7,993,133 (Cinader et al.). The virtual attachments may be at least partially designed and/or retrieved from a database. Each attachment or analog may be automatically and/or manually positioned relative to a virtual tooth in the virtual dental arch. Examples of systems for automatically placing and/or adjusting virtual appliances are described in U.S. Pat. No. 7,210,929 (Raby, et al.), U.S. Pat. No. 7,940,258 (Raby et al.) and U.S. Pat. No. 8,517,727 (Raby, et al.).

The desired locations for the attachment/analog on the model can be determined in any of a number of ways. For example, a user at an appliance manufacturer's facility may use modeling software to place analogs/appliances on a model of the patient's dental arch based on standards or guidelines from an orthodontic treatment philosophy, such as the straight wire technique outlines above. These standards or guidelines for appliance placement may be specific to each tooth in the model. A user may also place attachments/analogs in accordance with particular instructions provided by a different treating professional. Each attachment and each tooth may be manipulated as a separate object within the virtual environment and fixed in the position of each bracket within the environment relative to the coordinate system associated with the tooth of the corresponding bracket. Assuming the final positions meet with approval, the virtual analogs may be placed at locations corresponding to the virtual attachments.

In an exemplary implementation, the virtual analog is obtained based on (for example by modification of) a virtual attachment of the present disclosure, which is typically standardized by prescription and available “off-the-shelf”. The person skilled in the art will however recognize that the present methods and systems may likewise be used in combination with lingual and labial attachments that may be customized for each tooth of each patient, or a combination of custom and standard attachments. In one implementation, virtual attachments are selected from a library of pre-existing bracket constructions. Such fully-constructed appliances can be stored and accessible as CAD or STL files, for example. The appliance data can be either scanned in using above-described scanning technologies or generated directly with 3D data from published appliance profiles or other manufacturing specifications.

The virtual attachments can be used to generate the set of analogs based thereon. Each analog of the set of analogs is associated with a virtual attachment of the virtual set of attachments, and in certain cases represents a modification thereof. In one embodiment, a modification step comprises increasing a three-dimensional volume represented by the virtual appliance by selectively modifying only a portion of the appliance. For example, the modification step may comprise a flattening or reduction of an indentation present in the appliance shape. The modification step may further comprise at least partially filling a space between portions of the attachment shape or adding a virtual structure to the appliance shape. Undercuts, which may otherwise hinder the placement of the attachments into the tray or eventually prevent a transfer tray from being removed, may be minimized or removed. Further the modification step may comprise optionally reducing the three-dimensional volume by selectively modifying another portion of the attachment. For example, the modification step may comprise a rounding of an edge to account for abrasion of a physical attachment during a surface treatment step (for example during deflashing or polishing). Further the modification step may comprise maintaining or substantially of at least a portion of the original virtual attachment shape. The shape of each virtual analog may substantially correspond at least partially to the shape of one virtual attachments of the virtual set of attachments. The person skilled in the art will recognize various possibilities for modifying a shape, for example by change of an existing shape, adding or removing a shape, virtually copying, cutting, extending, reducing or another suitable technique. The skilled person will further be able to create a set of analogs in any suitable manner, for example by functions available on a CAD system, to provide a set of analogs in which the shape of at least one of the analogs differs from the shape of the associated appliance.

Appliance analogs may be stored as rendered in an accessible library or generated subsequent to retrieval based on an intended location of the attachment on the dental arch.

A virtual mockup may be provided by combining the virtual dental arch and the set of virtual analogs, for example being merged or superimposed by computer aid. The virtual mockup, which is preferably present in the form of a computer processable three-dimensional data file may be transmitted to an additive manufacturing machine which manufactures the physical mockup based on the virtual mockup. Alternatively, the components of the virtual mockup may be transmitted to the additive manufacturing machine and created separately, with a technician responsible for placement and coupling of the physical analog(s) or “off-the-shelf” attachments to a physical dental arch. Such a method may rely on guides or other devices created on the physical arch to assist in analog placement, such as those described in U.S. Pat. No. 7,762,815 (Cinader et al.) and U.S. Pat. No. 8,235,717 (Kuperman). Analogs or attachments may be held in place during formation of the transfer tray, for example, by a temporary adhesive or by friction fit with the guides as described, for example, in U.S. Pat. No. 7,762,815. Such methods may be particularly desirable when the prescribed attachments are selected from a pre-existing, physical inventory.

The physical mockup can be made of a light curable material but may in other examples be made of a plastic material (for example molten from a plastic fiber), metal, gypsum, cement or other chemically hardenable materials. Manufacturing may further include post-processing to remove uncured resin and remove support structures, or to assemble various components.

Once the physical mockup is generated to satisfaction, a transfer apparatus may be created over said mockup. This may include sending instructions to a pressure forming or thermoforming machine to cause one or more sheets of material to be pressure formed or thermoformed over the physical mockup to form a negative replica or shell. The sheet may be, for example, a sheet of deformable plastic (e.g., an elastic thermoplastic). The sheet of material may be heated to a temperature at which the sheet becomes pliable. Pressure may concurrently be applied to the sheet to form sheet around the mockup. Once the sheet cools, it will have a shape that conforms to the mockup. An interior shape of the plastic shell substantially conforms to the patient's current dental arch. A release agent can be applied to the mockup before forming the plastic shell to facilitate later removal of the mold from the plastic shell. The shell can be trimmed by laser or mechanical milling techniques to remove excess or unwanted material.

The removable dental appliance or set of appliances (e.g., CTA or polymeric band) may be molded from thermoplastic or thermosetting material over the physical mockup in a manner similar to forming the transfer tray. A physical mockup may be formed for each stage of treatment, with or without attachment devices. In some embodiments, as described above, the removable dental appliance may be formed via additive manufacturing.

One exemplary method of making a tray includes the use of multiple sheet materials as described in U.S. Pat. No. 10,368,961 (Paehl et al.). The method includes placing elastic sheeting on top of the occlusal side of the teeth represented by the physical mockup, with a plastic sheeting arranged on top of the elastic sheeting. The elastic sheeting and the plastic sheeting are deformed in directions toward the physical mockup. This may be achieved by a vacuum generated beneath the elastic and plastic sheeting or a pressure above the elastic and plastic sheeting. At least the plastic sheeting maybe heated before and/or during the deformation. The plastic sheeting is typically allowed to solidify by cooling so as to provide it with a sufficient rigidity for handling.

The method can, in other embodiments, optionally include placing elastomeric spacer over maloccluded tooth arch models and thermoforming hard layer of transfer tray (such as, for example, PETG) the models of maloccluded tooth arches with added attachment receptacles. In another example, rather than manufacturing the models of maloccluded tooth arches with added attachment pockets and thermoforming the transfer tray, the technique may include additive manufacturing of the transfer tray.

After forming the transfer tray, the methods of the present disclosure can include placing the unique tooth attachments into corresponding pockets (e.g., receptacles) in a transfer tray. For example, a clinician or technician may use a tool such as a tweezer, a retaining ring pliers, or other suitable tool to engage a coupling portion of an article to insert at least an attachment body into a respective recess in the transfer tray. In some examples, placing the attachments may include placing, by a pick-and-place robot, the attachments in the transfer tray. In this way, forming the transfer tray may be automated.

The methods of using the attachment also include placing a hardenable adhesive onto bonding surfaces of attachments. In some examples, a light-cure adhesive could be placed on the attachments before loading into the transfer tray. In some examples, other dental adhesives may be used, and the technique may include proper preparation and use of those adhesives (e.g., mixing of two part adhesives, application of curing agent, or the like). The teeth may optionally be etched or primed before the transfer tray is seated on the arch.

Once the attachments are seated in the receptacles, the transfer tray may be placed onto the dental arch and the adhesive cured. For example, curing the adhesive may include curing with a light source, such as a dental irradiation device, curing with an activating agent, and/or waiting a duration of time. Once the adhesive is suitably cured, the tray may be removed from the patient's mouth.

A combination treatment using the attachments of the present disclosure may commence with the patient treated using either or both a removable appliance and braces. Each phase of the treatment may include a series of removable appliance or archwires. In one embodiment, the treatment commences with the bonded attachments of the present disclosure initially used as brackets for an orthodontic brace. Small soft round archwires such as 0.012″D, 0.014″D and 0.016″D NiTi or braded stainless steel can be used with the attachments at this stage to efficiently unravel severely mal-occluded teeth. The brace, including archwire, may be periodically adjusted by the dental practitioner to reach an intermediate arrangement of the teeth, and the dental practitioner may determine whether the patient is ready for transition to CTAs. If not, the practitioner may continue to adjust or replace the archwire. The positions of the teeth after treatment with braces may be used to create a series of CTAs.

After satisfactory progress with the braces, the patient may wear a series of removable dental appliances. In an exemplary embodiment of this treatment, a first removable appliance is connected to the attachments to re-position a patient's maloccluded teeth to an intermediate dental arrangement. If the patient is progressing according to plan with the appliances, the next removable dental appliance in the treatment sequence is provided to the patient and the first appliance is removed. Next, a second arch member that has a configuration when relaxed that is different from the configuration of the first arch member when relaxed can be used in a similar fashion to re-position the patient's teeth from the intermediate dental arrangement to a subsequent or final dental arrangement. If desired, the above process can be extended to two or more intermediate dental arrangements. In one or more embodiments, the first and second removable appliances can include the same configuration, but the second removable appliance can have material properties that are different from the first removable appliance. For example, one or more portions of the removable appliance can include a stiffness that provides a corrective force or forces that are different from the corrective force or forces provided by the first removable appliance.

After wearing any number of CTAs or bands, the patient may return to the practitioner who may evaluate the result of the first iteration of treatment. In the event that the first iteration of treatment has resulted in satisfactory final placement of the patient's teeth, the treatment may be ended. However, if the first iteration of treatment did not complete the desired movement of the patient's teeth, one or more additional iterations of treatment may be performed. To begin the next iteration of treatment, the practitioner may take another scan of the patient's teeth to facilitate the design of the ordered set of removable dental appliances or selection of a new set of archwires. In some examples, evaluation of the result of the first iteration of treatment may include taking another scan of the patient's teeth, in which case beginning the next iteration of treatment may simply involve forwarding the digital model of the patient's teeth to a manufacturing facility so that another removable appliance or series of removable appliances may be manufactured for the patient based on the new positions of the patient's teeth. In yet other examples, the newly acquired scan may be used to create one or more iterations of removable appliances in the practitioner's facility.

In one or more embodiments that utilize progressive treatment of a patient's teeth, second, third, or more intermediate scans of the teeth can be performed using any suitable technique or combination of techniques. The practitioner or manufacturer can then utilize these intermediate scans to provide one or more additional appliances that are adapted to provide one or more corrective forces to the teeth such that one or more teeth are repositioned to either a subsequent intermediate arrangement or a final target arrangement. Any suitable technique or combination of techniques can be utilized to provide these intermediate scans, models, and arch members, e.g., the techniques described in U.S. Pat. No. 10,307,221 (Cinader, Jr.) and U.S. Pat. No. 10,426,574 B2 (Raby et al.).

The treating professional may also elect to treat the patient with a series of removable dental appliances and finish with braces. Alternatively, the treating professional may begin and finish with braces, with an intermediate stage accomplished with a removable appliance, or begin and finish with removable appliances, and end with braces.

Kits and assemblies of the appliance described are also contemplated herein. For example, one or more of the attachments described herein may be pre-coated with a suitable orthodontic adhesive and packaged in a container or a series of containers, as described for example in U.S. Pat. No. 4,978,007 (Jacobs et al.); U.S. Pat. No. 5,015,180 (Randklev); U.S. Pat. No. 5,429,229 (Chester et al.); and U.S. Pat. No. 6,183,249 (Brennan, et al.), and U.S. Patent Publication No. 2008/0286710 (Cinader et al.)

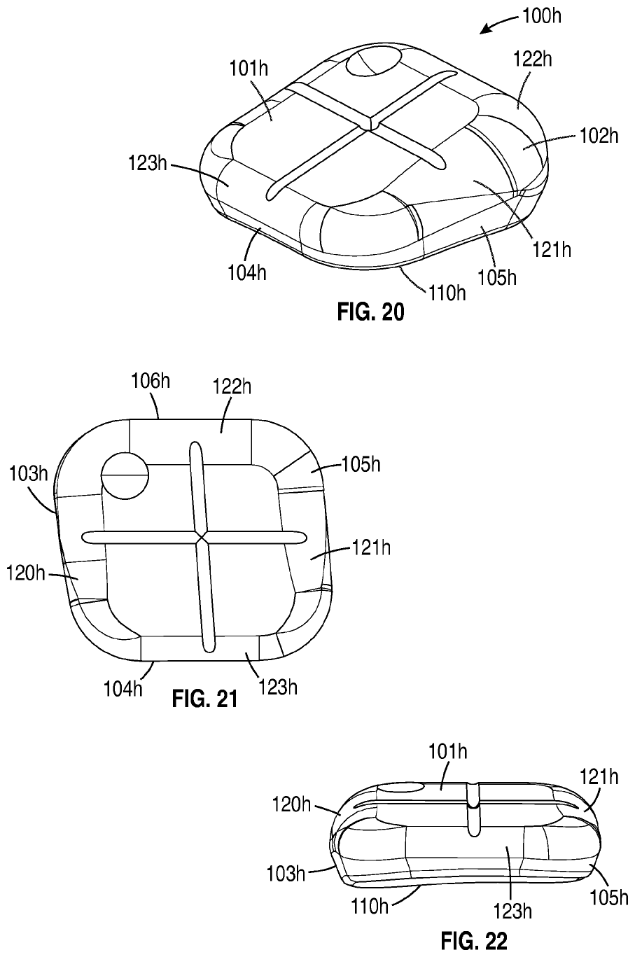

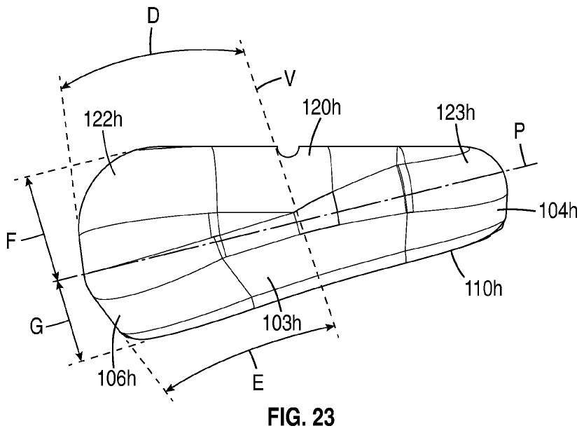

FIGS. 20-23 illustrate another exemplary attachment appliance 100h including an attachment body 102h and a bonding surface 110h that may be used in cooperation or in lieu of attachment appliances 100a-100g. Though not depicted, the appliance 100h may also be provided with an at least partially enclosed archwire slot similar to those of appliances 100a-100g. The appliance 100h includes tapering mesial, distal, and gingival side surfaces 103h, 105h, and 106h. Appliance 100h includes body 102h geometry to aid in the placement and retention of a tray, CTA, or arch member. The body 102h includes a mesial arcuate region 120h and a distal arcuate region 121h. The arcuate regions 120h, 121h each provide a surface transition between the facial surface 101h and the respective mesial side surface 103h or distal side surface 105h. The transition regions 120h, 121h include defined, compound curvature having a greater average arc length than similar transitions in attachment bodies 100a-100g. It is to be understood that many other aspects of attachment 100h may have similar form and function to those described in attachment 100a-100g and these need not be repeated.

The body 102h may further include a gingival, arcuate transition region 122h including defined, compound curvature between the facial surface 101h and the gingival side 106h, as well as an occlusal, arcuate transition region 123h including defined, compound curvature between the facial surface 101h and the occlusal side 104h. The greater amount of body 102h surface area represented by arcuate surfaces, as compared to attachment bodies 100a-100g, tends to aid the seating of the appliance 100h in a receptacle of a transfer tray, arch member, or CTA. Without wishing to be bound by theory, the arcuate surfaces can reduce the amount of frictional force necessary to engage the relatively rigid attachment with an elastomeric receptacle without necessarily sacrificing the undercuts necessary to retain the attachment appliance to avoid unintentional disengagement.

The presence of arcuate transition regions 120h, 121h, 122h tends to separate the appliance body 102h into buccolabial and lingual (i.e., closer to the bonding surface) zones 130h, 131h. The buccolabial zone 130h includes the facial surface 101h and the transition regions 120h, 121h, 122h and the lingual zone 131h includes the side surface 103h, 104h, 105h, 106h, and bonding surface 110h. A plane P generally parallel to the bonding surface 110h and passing through the points where the transition region 122h meets tapered gingival edge 106h separates the buccolabial zone 130h from the lingual zone 131k The labial zone 103h of the attachment usually slopes at an angle “D” relative to a vertical axis “V” that is normal to the attachment bonding surface. The lingual zone also forms an angle, “E”, with the vertical axis V. The labial zone has a maximum thickness of F, as measured between the plane P and the facial surface, and lingual zone has a maximum thickness of G, as measured between the plane P and the bonding surface 110b. For easy receptacle engagement with the attachment and good retention capability, typically D≤E and F≥G. The thickness of labial zone, depending on torque prescription, may have an increasing taper in the gingival direction. The relatively thinner occlusal region of the appliance body again favors easier insertion, while the thicker gingival regions may aid in receptacle retention.

The complete disclosures of the patents, patent documents, and publications cited herein are incorporated by reference in their entirety as if each were individually incorporated.

1. An orthodontic attachment device comprising:
an attachment body, a bonding surface underlying the body, and an at least partially enclosed archwire passage extending across the body;
wherein the attachment body has the general shape of an inverted frustrum, and wherein the attachment device lacks a flared base.

2. (canceled)

3. The orthodontic attachment device of claim 2, wherein the bonding surface is the underside of the attachment body.

4. The orthodontic attachment of claim 1, wherein the attachment body has a generally trapezoidal cross-sectional shape along at least one of a mesial-distal or occlusal-gingival axis.

5. The orthodontic attachment device of claim 1, wherein the attachment body includes mesial, distal, occlusal, and gingival side surfaces extending between a facial surface of the body and the bonding surface.

6. The orthodontic attachment device of claim 5, wherein side surfaces form a continuous undercut.

7. The orthodontic attachment device of claim 5, wherein the transition surface between any two side surfaces is arcuate.

8. The orthodontic attachment device of claim 7, wherein at least two side surfaces have the decreasing taper between a facial surface of body and the bonding surface

9. (canceled)

10. The orthodontic attachment device of claim 12, wherein the bonding surface is shaped to bond at the facial axis of the clinical crown of the tooth.

11. The orthodontic attachment device of claim 1 wherein the attachment body is dimensioned according to a prescription, the prescription including at least two of in/out, torque, and angulation.

12. The orthodontic attachment device of claim 1, wherein the first appliance body includes an occlusal slot guard projecting over a portion of the archwire slot, such that an archwire must be bent to be seated in the slot.

13. A system of appliances suitable for use as brackets and attachment devices, the system comprising:
A first appliance having a first body and a partially enclosed archwire slot extending laterally across the body, wherein the first attachment body has a first prescription including at least two defined prescription elements selected from in/out, torque and angulation;
A second appliance having a second body and an enclosed archwire slot extending laterally across the second body, wherein the second attachment body has a second prescription including at least two defined prescription elements selected from in/out, torque and angulation;
A third appliance having a second body and an enclosed archwire slot extending laterally across the third body, wherein the third attachment body has a third prescription including at least two defined prescription elements selected from in/out, torque and angulation,
wherein the first prescription is different than the second and third prescriptions, and wherein a least the first appliance lacks a base extending laterally outward from the body.

14. The system of claim 13, wherein the first appliance body includes a slot guard projecting over a portion of the archwire slot, such that an archwire must be bent to be seated in the slot.

15. The system of claim 14, wherein the guard has a semi-circular shape.

16. The system of claim 1, and further comprising a fourth appliance having a fourth body with a partially enclosed archwire slot, the fourth body including an underside surface at least approximating the contour of a central tooth.

17. (canceled)

18. The system of claim 13, wherein the underside surface of each appliance has a contour approximating the buccal radii of a dedicated tooth of a dental arch.

19. The system of claim 13, and further comprising at least one of an archwire for installation in each of the archwire slots; a tray including receptacles configured to accommodate a patient's teeth and the appliances; and polymer band configured to couple to and extend over a facial surface of each of the appliances.

20. The system of claim 19, wherein the band, when viewed from a direction perpendicular to the occlusal plane, defines a continuous arch including a non-undulating facial surface.

21. A method for combination orthodontic treatment, the method comprising;
providing a plurality of fixed appliances installed on a dental arch, the plurality of appliances including a first appliance having a first body and a partially enclosed archwire slot extending laterally across the body, wherein the first attachment body has a first prescription including at least two defined prescription elements selected from in/out, torque and angulation; a second appliance having a second body and an enclosed archwire slot extending laterally across the second body, wherein the second attachment body has a second prescription including at least two defined prescription elements selected from in/out, torque and angulation;
removing the archwire from each appliance of the plurality of appliances;
installing a polymeric, arch-shaped appliance on the dental arch, the member configured to engage at least the facial surfaces of each fixed appliance.

22-23. (canceled)

24. The method of claim 21, wherein a least the first appliance lacks a base extending laterally outward from the body.

25. The method of claim 21, wherein the first appliance body includes an occlusal slot guard projecting over a portion of the archwire slot, such that an archwire must be bent to be seated in the slot, and wherein the guard has a semi-circular shape.
